(19) United States
(12) Patent Application Publication
(10) Pub. No.: US 2009/0223741 A1
(43) Pub. Date: Sep. 10, 2009

(54) Perimeter safety system for pre-engineered roof system construction

(76) Inventor: Lee Joseph Picard, JR., Breaux Bridge, LA (US)

Correspondence Address: Jones, Walker, Waechter, Poitevent, Carrere,;Denegre, L.L.P., 5th Floor, Four United Plaza, 8555 United Plaza Boulevard, Baton Rouge, LA, 70809, US

(21) Appl. No.: 12/074,830

(22) Filed: Mar. 6, 2008

(51) Int. Cl. E04G 21/32; F16M 11/26; F16M 11/38

(52) U.S. Cl. 182/113; 248/188.5; 248/168

(57) ABSTRACT

A perimeter safety system used in pre-engineered metal building or roof system construction. The perimeter safety system includes a plurality of perimeter safety stands. Each perimeter safety stand has a main leg, a lateral support leg, and a perimeter leg. The lateral support leg and the perimeter leg may also be telescoping. The lower end of the main leg, lateral support leg and perimeter leg are each affixed to a panel foot. Each panel foot is capable of being detachably secured to a substructure and capable of being positioned between corrugations of an exposed fastener roof panel or detachably secured to a standing seam of a concealed fastener roof panel. The plurality of perimeter safety stands are interconnected with safety lines.

### FIELD OF THE INVENTION

The present invention relates to a perimeter safety system for pre-engineered roof system construction and more particularly to a perimeter safety system that includes a plurality of perimeter safety stands. Each perimeter safety stand contains a main leg, a lateral support leg, and a perimeter leg. Safety lines interconnect each perimeter safety stand.

### BACKGROUND OF THE INVENTION

Pre-engineered roof system construction poses occupational hazards to construction workers who must work above ground level and at such heights that their fall from the building may cause serious injury. The need exists for a perimeter safety system that may be easily installed, re-positioned as the structure is completed, and adaptable to a variety of different roof panels. Ease of re-positioning is important because as the roof is constructed with the placement of roof panels, each installed perimeter safety stand will need to be disconnected, the roof panel put in place, and the perimeter safety stand reconnected. Adaptability is also desirable so that the perimeter safety system can be used with roof systems having different panel configurations.

### SUMMARY OF THE INVENTION

It is an object of the present invention to provide a perimeter safety system that can be easily fastened to a substructure, unfastened as construction of the pre-engineered roof system progresses, and re-fastened to the substructure as the roof is completed.

It is also an object of the present invention to provide a perimeter safety system that is adaptable to a variety of metal roof panels such as R panels, M panels, trapezoid standing seam panels, and architectural standing seam panels.

The objects of the present invention are achieved by the novel perimeter safety system that includes a plurality of perimeter safety stands. Each perimeter safety stand has a main leg, a lateral support leg, and a perimeter leg. Each leg has an upper and a lower end. The lower end of each leg is connected to a panel foot that is capable of being detachably connected to a substructure of a pre-engineered roof system. Each panel foot is also capable of being positioned between corrugations of a roof panel or detachably connected to a standing seam of the roof panel. Because of its unique design, each perimeter safety stand can be unfastened from the substructure, a corrugated roof panel put into place, and the perimeter safety stand re-fastened to the substructure, or in the case where the roof panel has a standing seam, re-fastened to the standing seam.

The length of lateral support leg and perimeter leg may be adjusted to position the panel feet connected to each of the lower ends of the lateral support and perimeter legs at a variety of spatial positions on the roof to account for the specific location of substructure of the roof, valleys between corrugations of the roof panel, standing seams of the roof panels, or the slope of the roof, all of which may vary depending on the particular pre-engineered roof system being constructed.

### BRIEF DESCRIPTION OF THE DRAWINGS

FIG. 1 is a perspective view of an embodiment of the perimeter safety system positioned on a roof of a pre-engineered roof system.

FIG. 2 is a perspective view of an embodiment of the perimeter safety stand.

FIG. 2a is a partial-perspective view of the embodiment of the perimeter safety stand illustrated in FIG. 2 showing the connection of the main leg to the main leg panel foot.

FIG. 2b is a partial-perspective view of the embodiment of the perimeter safety stand illustrated in FIG. 2 showing the connection of the lateral support leg to the lateral support leg panel foot.

FIG. 2c is a partial-perspective view of the embodiment of the perimeter safety stand illustrated in FIG. 2 showing the connection of the perimeter leg to the perimeter leg panel foot.

FIG. 3 is a perspective view of the embodiment of the perimeter safety stand showing the placement of the panel feet between the corrugations of an exposed fastener roof panel.

FIG. 3a is a cross-sectional view taken along lines 3A-3A of the embodiment of the perimeter safety stand of FIG. 3 showing the attachment of main panel foot to a substructure of the metal building.

FIG. 4 is an exploded perspective view of the embodiment perimeter safety stand showing the connection of upper ends of the main, lateral support and perimeter legs and insertion points for the upper and lower legs.

FIG. 4a is partial, exploded perspective view of the embodiment of the perimeter safety stand illustrated in FIG. 4 showing the connection of the upper ends of the main, lateral support and perimeter legs.

FIG. 5 is partial perspective view of an alternative embodiment of the perimeter safety stand showing the connection of a panel foot to a standing seam of a concealed fastener roof panel.

FIG. 5a is cross-sectional view taken along lines 5A-5A of the alternative embodiment of the perimeter safety stand of FIG. 5 showing the connection of main leg panel foot to the standing seam of a concealed fastener roof panel.

FIG. 6 is a perspective view of a standing seam fixation member.

FIG. 7 is a partial perspective view of the embodiment of the perimeter safety stand showing the attachment of safety lines thereto.

### DETAILED DESCRIPTION OF PREFERRED EMBODIMENTS

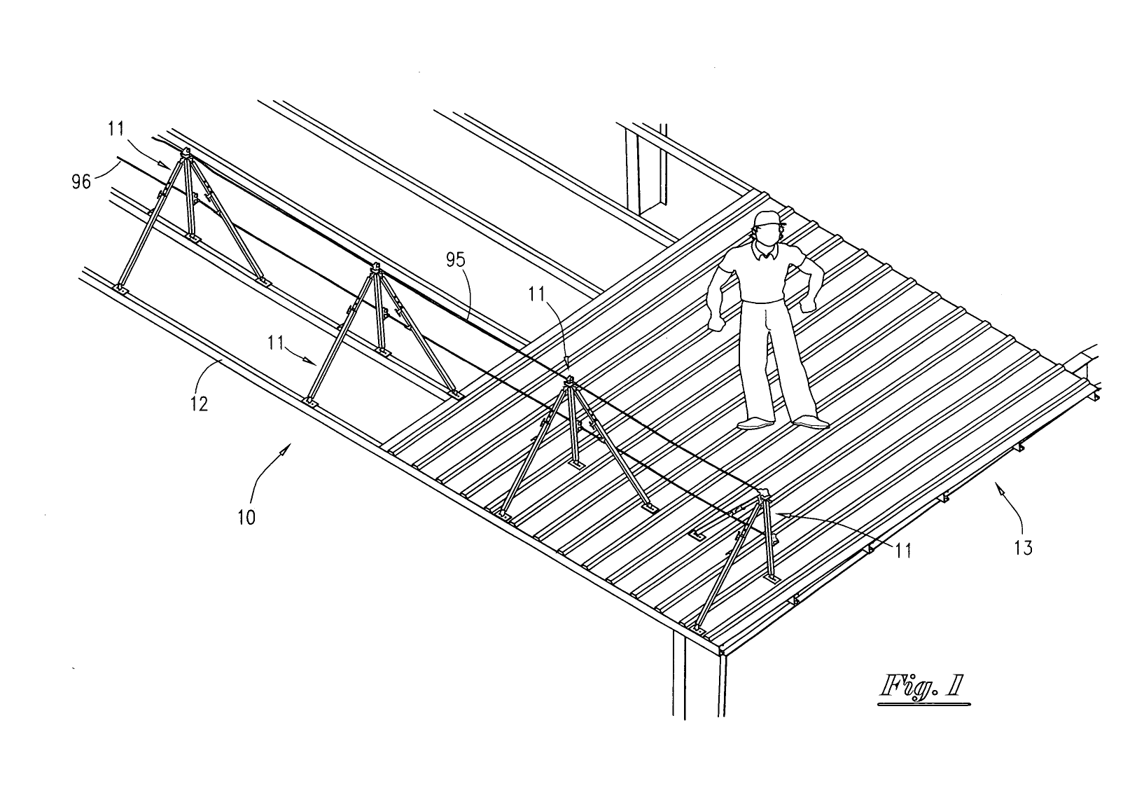

With reference to the figures where like elements have been given like numerical designation to facilitate an understanding of the present invention, and particularly with reference to the embodiment of the perimeter safety system illustrated in FIG. 1, perimeter safety system 10 is depicted as including two or more perimeter safety stands 11 positioned along the perimeter or edge 12 of pre-engineered roof system 13. The number of perimeter safety stands 11 constituting or included within perimeter safety system 10 may vary depending on the size of pre-engineered roof system 13 and the area desired to be protected by perimeter safety system 10.

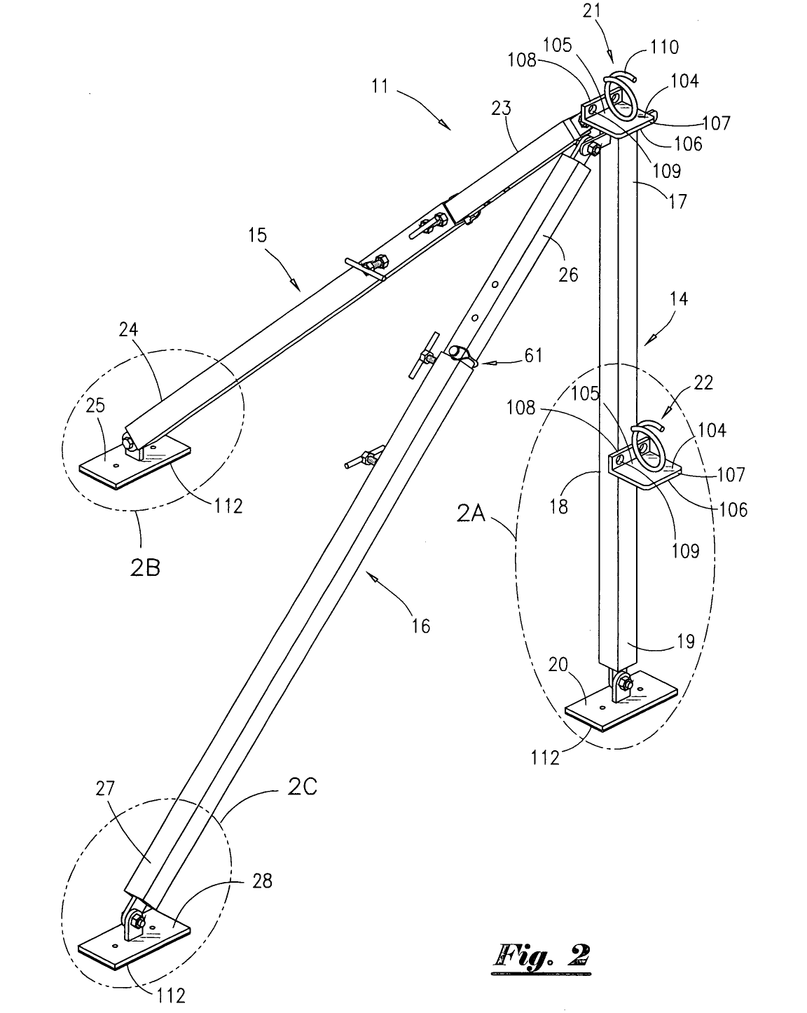

As shown in FIG. 2, each perimeter safety stand 11 may include main leg 14, lateral support leg 15, and perimeter leg 16. Main leg 14 may include upper end 17, middle section 18, and lower end 19. Lower end 19 of main leg 14 may be detachably connected to main leg panel foot 20. Upper end 17 of main leg 14 may include upper safety line receptacle 21. Middle section 18 of main leg 14 may have middle safety line receptacle 22.

Again with reference to FIG. 2, lateral support leg 15 may have upper end 23 and lower end 24. Lower end 24 of lateral support leg 15 may be detachably connected to lateral support leg panel foot 25. Upper end 23 of lateral support leg 15 may be detachably connected to upper end 17 of main leg 14.

FIG. 2 also shows that perimeter leg 16 may have upper end 26 and lower end 27. Lower end 27 of perimeter leg 16 may be detachably connected to perimeter leg panel foot 28. Upper end 26 of perimeter leg 16 may be detachably connected to upper end 17 of main leg 14.

Referring to FIG. 2a, lower end 19 of main leg 14 may include bracket 32 with bolt hole 33. Main leg panel foot 20 may include bracket 34 with bolt hole 35. Bracket 32 may be detachably connected to bracket 34 by bolt 36 extending through bolt holes 33, 35 and held in place by nut 37.

As shown in FIG. 2b, lower end 24 of lateral support leg 15 may include bracket 38 with bolt hole 39. Lateral support leg panel foot 25 may include bracket 40 with bolt hole 41. Bracket 38 may be detachably connected to bracket 40 by bolt 42 extending through bolt holes 39, 41, and held in place by nut 43.

FIG. 2c reveals that lower end 27 of perimeter leg 16 may include bracket 44 with bolt hole 45. Perimeter leg panel foot 28 may include bracket 46 with bolt hole 47. Bracket 44 may be detachably connected to bracket 46 by bolt 48 extending through bolt holes 45, 47, and held in place by nut 49.

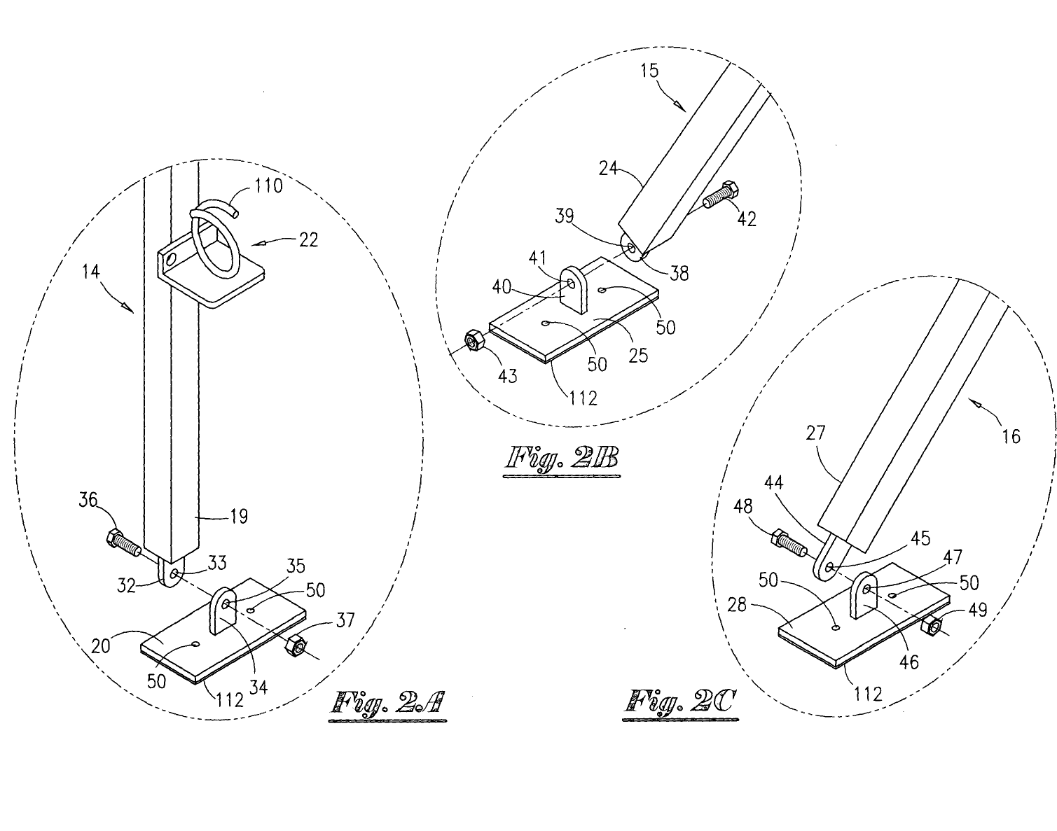

As illustrated in FIG. 3, main leg panel foot 20, lateral support leg panel foot 25, and perimeter leg panel foot 28 are each capable of being detachably connected to substructure 29 of pre-engineered roof system 13. Preferably, substructure 29 is a purlin and more preferably a double-nested purlin. Main leg panel foot 20, lateral support leg panel foot 25 and perimeter leg panel foot 28 are also each capable of being positioned crosswise between corrugations 30 of exposed fastener roof panel 31.

FIG. 3a shows that main leg panel foot 20 may include at least two screw holes 50. Screws 51 may be inserted through screw holes 50 to detachably connect main leg panel foot 20 to substructure 29 of pre-engineered roof system 13. Main leg panel foot 20 is positioned crosswise between corrugations 30 of exposed fastener roof panel 31. Likewise, each of lateral support leg panel foot 25 and perimeter leg panel foot 28 may be affixed crosswise between corrugations 30 of exposed fastener roof panel 31.

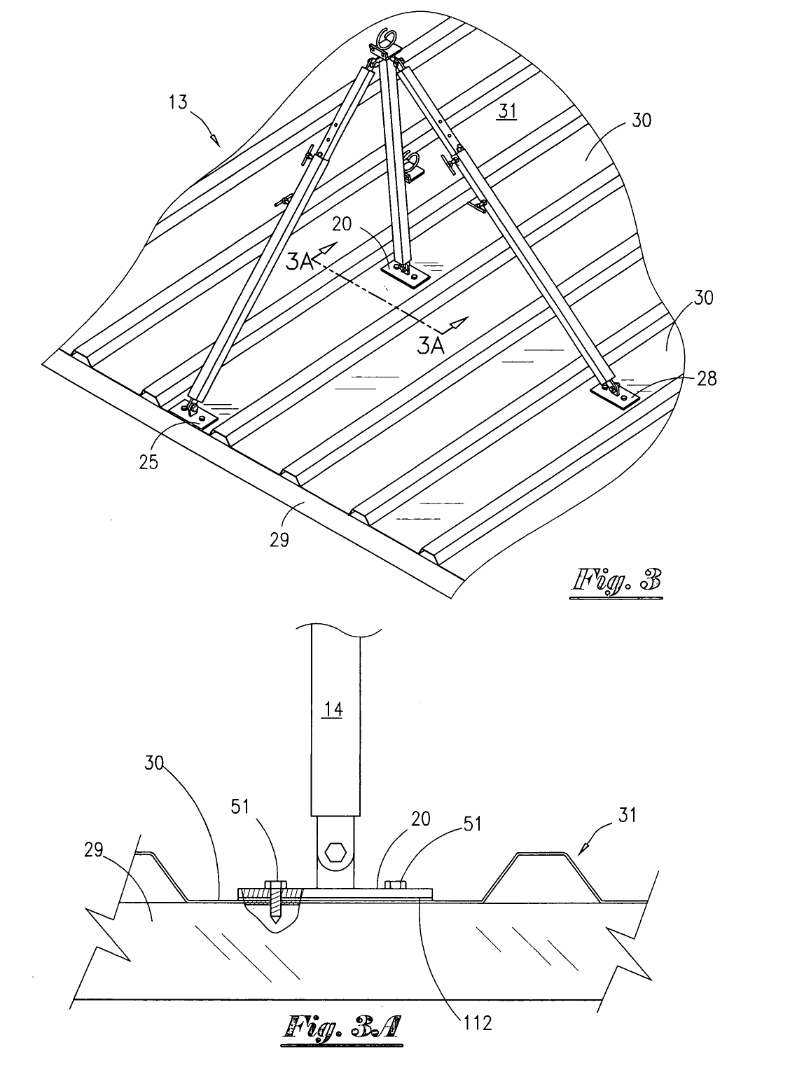

As illustrated in FIGS. 2 and 4, lateral support leg 15 may be a telescoping leg with lower leg section 52 and upper leg section 53. Upper leg section 53 may be insertable into lower leg section 52 and be extendable and retractable within lower leg section 52 so that the length of lateral support leg 15 may be selectively adjusted to position lateral support leg panel foot 25 on pre-engineered roof system 13 during construction. The telescoping feature of lateral support leg 15 enables the slope of perimeter safety stand 11 to be adjusted so that main leg 14 is substantially perpendicular to exposed fastener roof panel 31.

As shown in FIGS. 2 and 4, upper leg section 53 may be secured within lower leg section 52 after selecting the length of lateral support leg 15. Lower leg section 52 may have one or more adjustment keys 56 insertable into and through key hole nut 57 in lower leg section 52 to brace or wedge against upper leg section 53 thereby keeping upper leg section 53 stationary within lower leg section 52. Adjustment key 56 may be any type of object that can apply a force to upper leg section 53 to keep it from moving (extending or retracting) within lower leg section 52. Adjustment key 56 may be a hand-threaded bolt.

Two adjustment keys 56 may be provided on lower leg section 52. Upper leg section 53 may also have two or more spaced-apart pin holes 54. Detachable pin with circular safety clip 55 may be placed into one of pin holes 54. Detachable pin with circular safety clip 55 acts as a secondary stop, preventing upper leg section 53 from retracting further or completely within lower leg section 52. Detachable pin with circular safety clip 55 may be attached to lower leg section 52 by lanyard 111. Lanyard 111 may be secured to adjustment key 56.

As also shown in FIGS. 2 and 4, perimeter leg 16 may be a telescoping leg with lower leg section 58 and upper leg section 59. Upper leg section 59 may be insertable into lower leg section 58 and be extendable and retractable within lower leg section 58 so that the length of perimeter leg 16 may be selectively adjusted to position perimeter leg panel foot 28 on pre-engineered roof system 13 during construction.

Again with reference to FIGS. 2 and 4, upper leg section 59 may be secured within lower leg section 58 after selecting the length of perimeter leg 16. Lower leg section 58 may have one or more adjustment keys 62 insertable into and through key hole nut 63 in lower leg section 58 to brace or wedge against upper leg section 59 thereby keeping upper leg section 59 stationary within lower leg section 58. Adjustment key 62 may be any type of object that can apply a force to upper leg section 59 to keep it from moving (extending or retracting) within lower leg section 58. Adjustment key 62 may be a hand-threaded bolt.

Two adjustment keys 62 may be provided on lower leg section 58. Upper leg 59 may also have two or more spaced-apart pin holes 60. Detachable pin with circular safety clip 61 may be placed into one of pin holes 60. Detachable pin with circular safety clip 61 acts as a secondary stop, preventing upper leg section 59 from retracting further or completely within lower leg section 58. Detachable pin with circular safety clip 61 may be attached to lower leg section 58 by lanyard 111. Lanyard 111 may be secured to adjustment key 62.

FIG. 4a shows that upper end 17 of main leg 14 may include first bracket 64 with bolt hole 65 and second bracket 66 with bolt hole 67. Upper end 23 of lateral support leg 15 may include bracket 68 with bolt hole 69. Upper end 26 of perimeter leg 16 may include bracket 70 with bolt hole 71. Upper end 23 of lateral support leg 15 may be connected to upper end 17 of main leg 14 by detachably connecting first bracket 64 of upper end 17 of main leg 14 and bracket 68 of upper end 23 of lateral support leg 15 via bolt 72 extending through bolt holes 65, 67, and held in place by nut 73.

Upper end 26 of perimeter leg 16 may be connected to upper end 17 of main leg 14 by detachably connecting second bracket 66 of upper end 17 of main leg 14 and bracket 70 of upper end 26 of perimeter leg 16 via bolt 74 extending through bolt holes 67, 71, and held in place by nut 75. First and second brackets 64, 66 on upper end 17 of main leg 14 may each extend outwardly and perpendicular to main leg 14. Upper end 17 of main leg 14 may also include third bracket 114 that can be used as a connection means for either of lateral support leg 15 or perimeter leg 16 as described above.

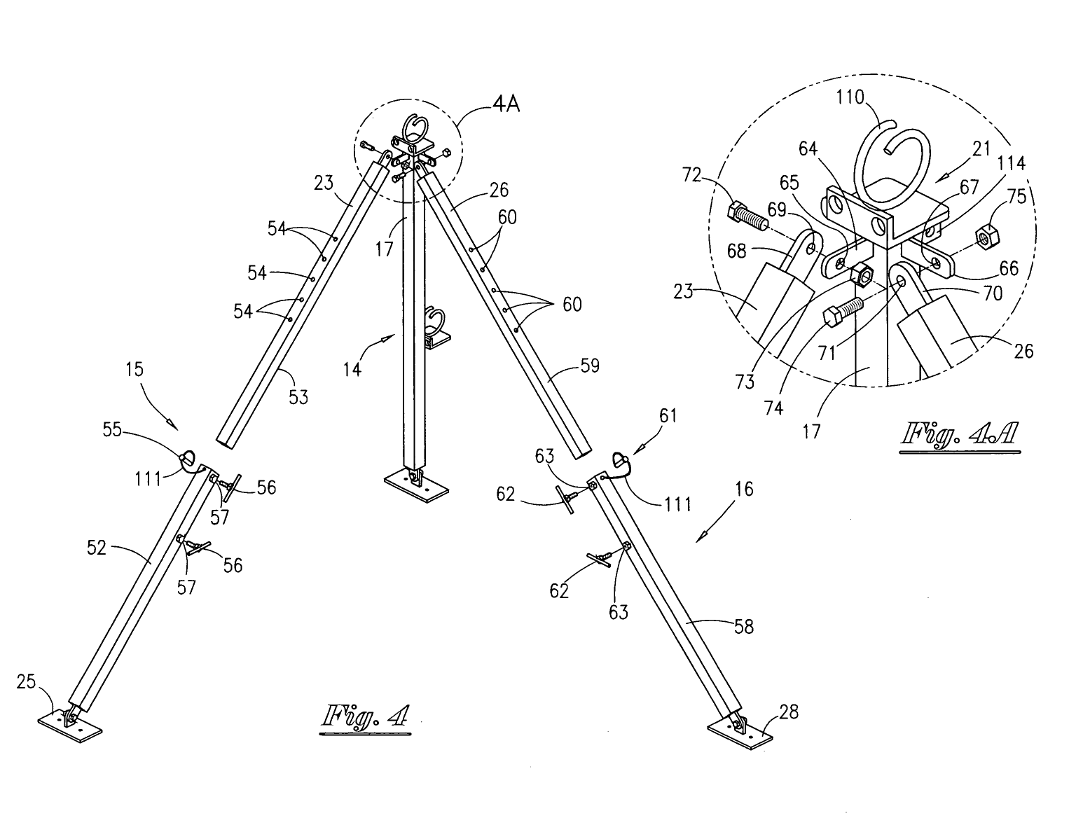

FIG. 5 shows an alternative embodiment of perimeter safety stand 11 in which perimeter leg panel foot 28 is made adaptable for fixation to standing seam 76 of concealed fastener roof panel 113 when roof system panel 31 is in the form of a trapezoid standing seam panel or an architectural standing seam panel. It is to be understood that main leg panel foot 20 and lateral support leg panel foot 25 may also be made adaptable for fixation to standing seam 76 of concealed fastener roof panel 113 when roof system panel 31 is in the form of a trapezoid standing seam panel or an architectural standing seam panel.

FIGS. 5 and 5a show the alteration to perimeter leg panel foot 28 that results in the adaptability for fixation to standing seams 76. Perimeter leg panel foot 28 may have top surface 77, bottom surface 78, and interconnecting side surfaces 79. First standing seam fixation means 80 may be detachably connected to bottom surface 78 of perimeter leg panel foot 28. Second standing seam fixation means 81 may be detachably connected to bottom surface 78 of perimeter leg panel foot 28. It is to be understood that main leg panel foot 20 and lateral support leg panel foot 25 may each be made adaptable in the same manner as perimeter leg panel foot 28 as described hereinabove.

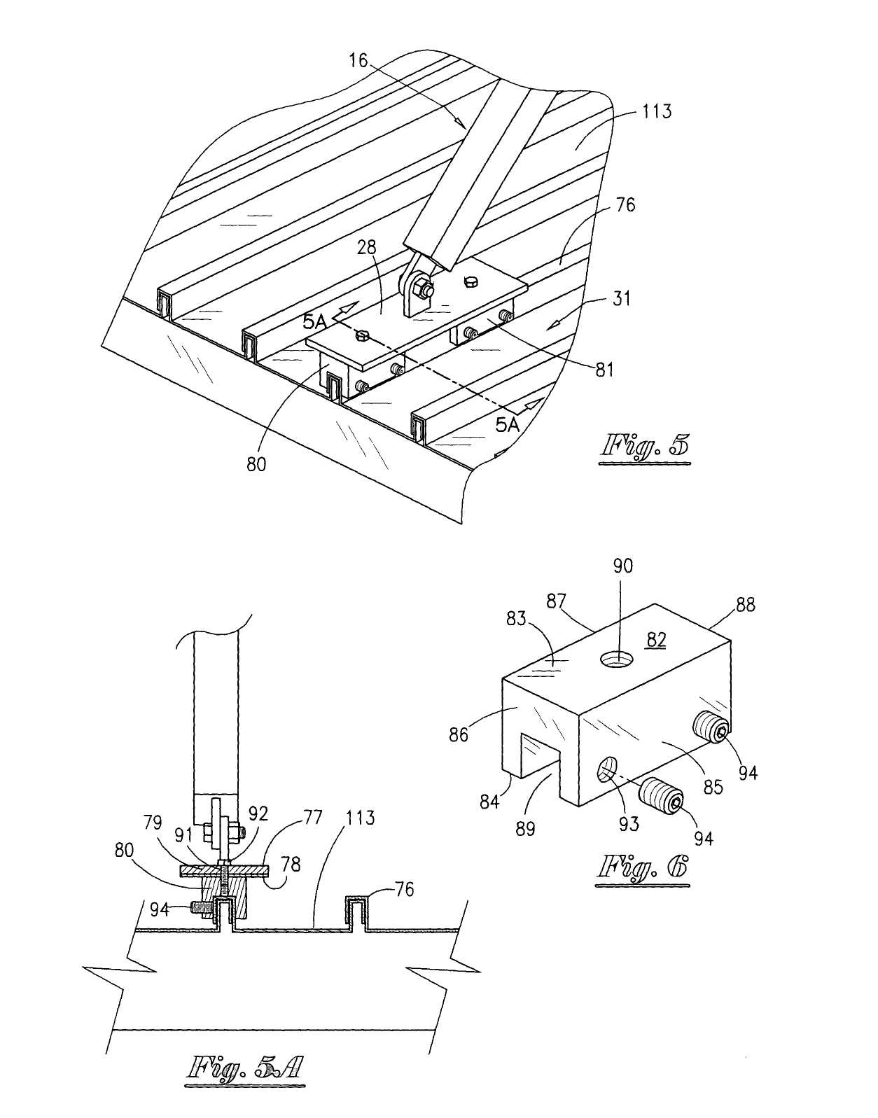

FIGS. 5a and 6 depict first and second standing seam fixation means 80, 81. First and second standing seam fixation means 80, 81 may each be a U-shaped rectangular block 82 with top surface 83, bottom surface 84, and interconnecting side surfaces 85, 86, 87, and 88. U-shaped rectangular block 82 may have cut-out area 89 which may receive and accommodate standing seam 76 of concealed fastener roof panel 113. Each standing seam fixation means 80, 81 may have bolt hole 90 running from top surface 83 through to cut-out area 89. Preferably, U-shaped rectangular block 82 is an S-5!™ clamp commercially available from Metal Roof Innovation, Ltd. of Colorado Springs, Colo.

To detachably connect first standing seam fixation means 80 to perimeter leg panel foot 28, hole 90 in top surface 83 of U-shaped rectangular block 82 is aligned with one of holes 91 in perimeter leg panel foot 28. Bolt 92 is run through hole 91 and threadedly connected to hole 90 to thereby detachably connect first standing fixation means 80 to perimeter leg panel foot 28.

Second standing seam fixation means 81 is detachably connected to perimeter leg panel foot 28 by aligning hole 90 in U-shaped rectangular block 82 with the second hole 91 in perimeter leg panel foot 28. A second bolt 92 is run through hole 91 and threadedly connected to hole 90 to thereby detachably connect second standing fixation means 81 to perimeter leg panel foot 28. In the same manner, first and second standing fixation means 80, 81 may be detachably connected to each of main leg panel foot 20 and lateral support leg panel foot 25.

With reference to FIG. 6, U-shaped rectangular block 82 may have two or more holes 93 in side 85 that run through and enter cut-out area 89. Camming device 94 may be inserted into each hole 93. Camming devices-94 act to clamp U-shaped rectangular block 82 to standing seam 76 of concealed fastener roof panel 113 when standing seam 76 is positioned within cut-out area 89 of U-shaped rectangular block 82. Holes 93 may be threaded. Camming device 94 may be a thread bolt.

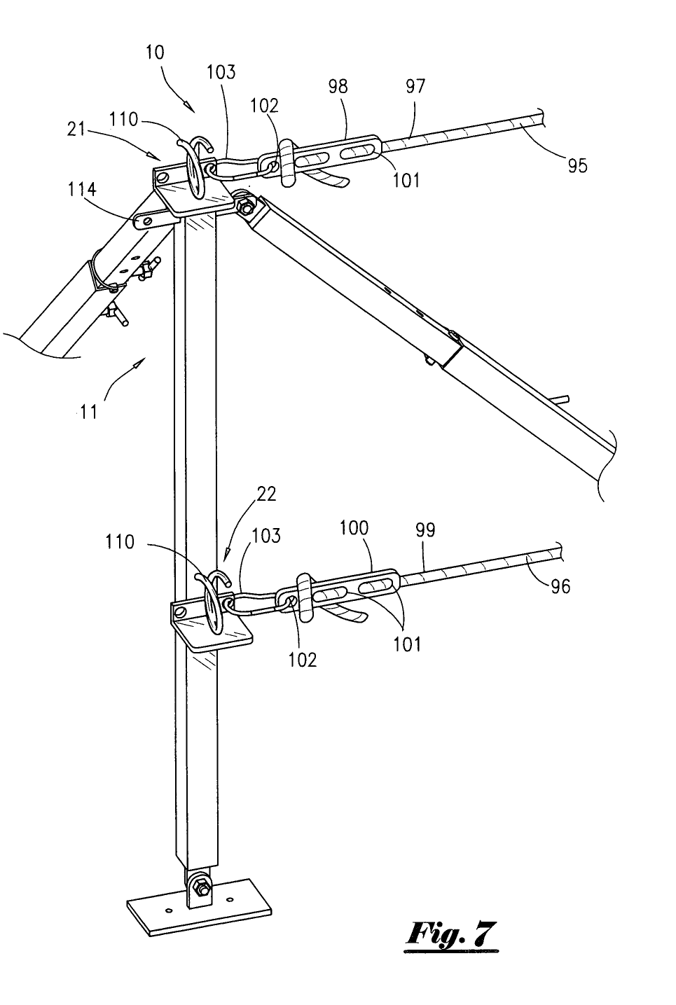

As shown in FIGS. 1 and 7, upper safety line 95 may be run through, positioned within, or connected to upper safety line receptacle 21 of each perimeter safety stand 11. Middle safety line 96 may be run through, positioned within, or connected to middle safety line receptacle 22 of each perimeter safety stand 11.

FIG. 7 illustrates that the ends of upper safety line 95 and the ends of middle safety line 96 may be anchored to the corner or end perimeter safety stands 11 in the series of perimeter safety stands 11 constituting perimeter safety system 10. The anchoring of the ends of upper and middle safety lines 95, 96 may be employed on one or more perimeter safety stands 11 depending on how many perimeter safety stands 11 form the end or corner perimeter safety stand 11 within perimeter safety system 10. There may be two perimeter safety stands 11 that act as the end or corner perimeter safety stands 11 within perimeter safety system 10.

Again with reference to FIG. 7, each of opposite end sections 97 of upper safety line 95 may be anchored or tied to upper anchor device 98. Each of opposite ends 99 of middle safety line 96 may be anchored or tied to middle anchor device 100. Upper anchor devices 98 each may have spaced-apart holes 101 through which end section 97 of upper safety line 95 may be wound and tied.

Upper anchor devices 98 each may have holes 102 for detachable connection of snap hook or carabiner 103. Snap hook or carabiner 103 may be detachably secured to upper safety line receptacle 21 of the corner or end perimeter safety stand 11 to anchor upper safety line 95. Middle anchor devices 100 each may have spaced-apart holes 101 through which end section 99 of middle safety line 96 may be wound and tied.

Middle anchor devices 100 each may have holes 102 for detachable connection of snap hook or carabiner 103. Snap hook or carabiner 103 may be detachably secured to middle safety line receptacle 22 of the corner or end perimeter safety stand 11 to anchor middle safety line 96.

Upper and middle anchor devices 98, 100 may be “Hold Me Anchor” anchor means commercially available from Guardian Fall Protection of Kent, Wash.

With reference to FIGS. 2 and 7, upper and middle safety line receptacles 21, 22 may be any object capable of retaining upper and middle safety lines 95, 96. Upper and middle safety line receptacles 21, 22 may each be formed of plate 104. Plate 104 may have top surface 105, bottom surface 106, and interconnected sides 107. Plate 104 may have L-shaped portion 108. L-shaped portion 108 may have one or more holes 109 for receiving snap hooks or carabiners 103 to anchor safety lines 95, 96 to end or corner perimeter safety stands 11. Plate 104 may have horn 110. Horn 110 may be affixed to top surface 105 of plate 104. Horn 110 receives, retains, or accommodates upper and/or middle safety lines 95, 96.

Again with reference to FIGS. 2 and 7, upper safety line receptacle 21 may be affixed to upper end 17 of main leg 14 by permanently securing bottom surface 106 of plate 104 to upper end 17 of main leg 14. Middle safety line receptacle 22 may be affixed to middle section 18 of main leg 14 by permanently securing bottom surface 106 at L-shaped portion 108 of plate 104 middle section 18 of main leg 14.

Perimeter safety system 10 is designed and engineered to be used as a guardrail system that constitutes a part of a means of fall protection for workers constructing pre-engineered roof system 13. Perimeter safety system 10 is not meant to be used as an anchorage point for fall protection. Perimeter safety system 10, used in conjunction with an approved safety net, is an acceptable fall protection system that can be used with pre-engineered metal building or roof construction. Perimeter safety system 10 is designed to be used on buildings having a low slope roof of 3:12 or less.

Main leg 14, lateral support leg 15, and perimeter leg 16 of perimeter safety stand 11 may each be made of steel or other hard material. Main leg 14, lateral support leg 15, and perimeter leg 16 may each be tubular in design. Main leg 14, lateral support leg 15, and perimeter leg 16 may each be a rectangularly-shaped tube.

Main leg 14 may have the following dimensions: length 41″, width 1½″, thickness 14 gauge.

Lateral support leg 15 may have the following dimensions: upper section 53, 71—length 53″, width 1¼″, thickness ⅛″; lower section 52, 70—length 52″, width 1½″, thickness 14 gauge, diameter of hole 54 ⅜″. Length of lateral support leg 15 in fully extended position 80 ¼″ and fully retracted 60 ¼″.

Perimeter leg 16 may have the following dimensions: upper section 53, 71—length 53″, width 1¼″, thickness ⅛″; lower section 52, 70—length 52″, width 1½″, thickness 14 gauge, diameter of hole 54 ⅜″. Length of perimeter leg 16 in fully extended position 80 ¼″ and fully retracted 60 1¼″.

Bracket 32 may be made of steel or other hard material and may be welded to lower end 19 of main leg 14. Bracket 38 may be made of steel or other hard material and may be welded to lower end 24 of lateral support leg 15. Bracket 44 may be made of steel or other hard material and may be welded to lower end 27 of perimeter leg 16.

Brackets 32, 38, 44 may each have the following dimensions: length 2½″, width 1¼″, thickness ¼″; and diameter of holes 33, 39, 45 is 5/16″.

First bracket 64 and second bracket 66, may each be made of steel or other hard material and may each be welded to upper end 17 of main leg 14. Bracket 68 may be made of steel or other hard material and may be welded to upper end 23 of lateral support leg 15. Bracket 70 may be made of steel or other hard material and may be welded to upper end 26 of perimeter leg 16. Brackets 64, 66, 68, 70 may each have the following dimensions: length 2½″, width 1¼″, thickness ¼″; and diameter of bolt holes 65, 67, 69, 71 is 5/16″.

Main leg panel foot 20, lateral support leg panel foot 25, and perimeter leg panel foot 28 may each be made of steel or other hard material. Panel feet 20, 25, 28 may each have the following dimensions: length 9¼″, width 4″, thickness ¼″, diameter of screw holes 50 is 3/16.″

Brackets 34, 40, 46 may each be made of steel or other hard material and may each be welded to respective panel feet 20, 25, 28. The dimensions of brackets 34, 40, 46 may each be length 2½″, width 1¼″, thickness ¼″, diameter of bolt holes 35, 41, 45 is 5/16″.

First and second standing seam fixation means 80, 81 and may each be made of steel, aluminum, or other hard metal. The dimensions of U-shaped rectangular block 82 may be: height 2½″, width 1½″, length 3″, width of cutout area 89 is ½″, diameter of bolt hole 90 is 5/16″, diameter of holes 93 is 5/16″. As previously mentioned, U-shaped rectangular blocks 82 may be S-5!™ clamps commercially available from Metal Roof Innovations, Ltd. of Colorado Springs, Colo.

Upper safety line receptacle 21 and middle safety line receptacle 22 may each be made of steel or other hard material and may be welded to main leg 14. Plate 104 may have the following dimensions: length 7″ with L-shaped portion 108 having a length of 2½″, width 4″, thickness ¼″, diameter of holes 109 is ¾″.

If upper safety line receptacle 21 and middle safety line receptacle 22 are in the form of a ring, the diameter of the ring may be 1⅞″ O.D. and 1½″ I.D.

Detachable pins with circular safety clips 55, 61 may be made of steel, aluminum, or other hard material.

Upper anchor device 98 and middle anchor device 100 may each be made of steel, aluminum, or other hard material that has a minimum strength rating of 200 lbs. As mentioned earlier, upper anchor device 98 and middle anchor device 100 may each be “Hold Me Anchor” anchor means commercially available from Guardian Fall Protection of Kent, Wash.

Snap hooks or carabiners 103 may be a snap hook available commercially from a variety of suppliers including manufacturer Guardian Fall Protection or a carabiner also available commercially from Guardian Fall Protection or other suppliers. Snap hooks or carabiners 103 may be made of steel, aluminum, or other hard material.

Except for end walls, each perimeter safety stand 11 may be attached at every frame line where substructure 29 is capable of supporting perimeter safety stand 11 (e.g., where zee purlins are double-nested). Panel feet 20, 25, 28 of each perimeter safety stand 11 may be affixed to the substructure 29 (e.g., double-nested purlin) by at least two screws 51 such as ZAC Impax ⅜″ #12-14 screws or an equivalent screw. Screws 51 should not be over-tightened as stripped out screws are not acceptable. A ZAC Impax #17 screw or equivalent is acceptable for use in stripped areas.

The perimeter safety system 10 may be installed on the perimeter 12 of pre-engineered roof system 13 prior to installation of exposed fastener roof panels 31. Once installation of panels 31 begins, each perimeter safety stand 11 will need to be unfastened from substructure 29 so that panel 31 may be placed in that location. When panel 31 is in place, perimeter safety stand 11 may be fastened back down to substructure 29 using new screws 51. Panel feet 20, 25, 28 are each designed to lie between the highs or standing seams 76 of corrugations 30 of exposed fastener roof panel 31. Rubber mat 112 may be attached to bottom surface 78 each panel foot 20, 25, 28 and to seal off screw 51 penetrations and prevent corrosion.

Upper and middle safety lines 95, 96 may each be a minimum of ⅝″ polypropylene fiber rope or its equivalent (minimum working load limit of 200 lbs. or greater is required). It is to be understood that safety lines 95, 96 may be a polypropylene fiber rope or other similar rope or line having a diameter that is greater than ⅝″. To terminate ends 97 and 99 of respective safety lines 95, 96, “Hold Me Anchor” anchor devices 98, 100 made by Guardian Fall Protection may be used. Plastic flaggins [not shown] cut into 12″ long sections may be attached about every 6′ along each of safety lines 95, 96.

Once the perimeter safety system 10 is installed, bolts 36, 42, 48, 72, 74 and all “T” handles on main leg 14, lateral support leg 15, and perimeter leg 16 may be hand tightened. Bolts 36, 42, 48, 72, 74 may each be A-325 bolts. After hand-tightening each bolts 36, 42, 48, 72, 74, detachable safety pin with circular safety clip 55 may be inserted into one of holes 54 of lateral support leg 15 to fix the length of lateral support leg 15 and prevent upper leg section 53 from sliding into lower leg section 52 of lateral support leg 15 and detachable safety pin with circular safety clip 61 may be inserted into one of holes 60 of perimeter leg 16 to fix the length of perimeter leg 16 and prevent upper leg sections 59 from sliding into lower leg section 58 of perimeter leg 16.

While preferred embodiments of the present invention have been described, it is to be understood that the embodiments described are illustrative only and that the scope of the invention is to be defined solely by the appended claims when accorded a full range of equivalence, many variations and modifications naturally occurring to those skilled in the art from a perusal hereof.

What is claimed is:

1. A perimeter safety system, comprising:
a plurality of perimeter safety stands, each perimeter safety stand comprising:
a main leg having an upper end, a middle section, and a lower end, said lower end capable of being detachably connected to a main leg panel foot, said upper end including an upper safety line receptacle, said middle section including a middle safety line receptacle;
a telescoping lateral support leg having an upper end and a lower end, said lower end capable of being detachably connected to a telescoping lateral support leg panel foot, said upper end capable of being detachably connected to said upper end of said main leg;
a telescoping perimeter leg having an upper end and a lower end, said lower end capable of being detachably connected to a telescoping perimeter panel foot, said upper end capable of being detachably connected to said upper end of said main leg;
wherein said main leg panel foot, said telescoping lateral support leg panel foot, and said telescoping perimeter leg panel foot are each capable of being detachably connected to a substructure of a pre-engineered roof system and positioned between corrugations of an exposed fastener roof panel.

2. The perimeter safety system according to claim 1, wherein each of said telescoping lateral support leg and said telescoping perimeter leg comprises a lower leg section and an upper leg section, said upper leg section capable of being insertable into said lower leg section and extendable and retractable therein so that a length of said leg may be selectively adjusted.

3. The perimeter safety system according to claim 1, wherein said upper safety line receptacle is capable of accommodating an upper safety line and said middle safety line receptacle is capable of accommodating a middle safety line.

4. The perimeter safety system according to claim 3:
wherein said upper safety line includes opposite end sections, each of said opposite end sections capable of being detachably connected to an upper anchor device; and
wherein said middle safety line includes opposite end sections, each of said opposite end sections capable of being detachably connected to a middle anchor device.

5. The perimeter safety system according to claim 4, wherein each of said upper anchor device and said middle anchor device includes a snap hook or carabiner.

6. The perimeter safety system according to claim 5, further comprising:
a means for detachably connecting said lower end of said main leg to said main leg panel foot;
a means for detachably connecting said lower end of said telescoping lateral support leg to said telescoping lateral support leg panel foot; and
a means for detachably connecting said lower end of said telescoping perimeter leg to said telescoping perimeter leg panel foot.

7. The perimeter safety system according to claim 6, further comprising:
a means for detachably connecting said upper end of said telescoping lateral support leg to said upper end of said main leg; and
a means for detachably connecting said upper end of said telescoping perimeter leg to said upper end of said main leg.

8. The perimeter safety system according to claim 7, further comprising:
a means for detachably connecting said main leg panel foot to said substructure of said pre-engineered roof system;
a means for detachably connecting said telescoping lateral support leg panel foot to said substructure of said pre-engineered roof system; and
a means for detachably connecting said telescoping perimeter leg panel foot to said substructure of said pre-engineered roof system.

9. The perimeter safety system according to claim 2, further comprising a means for retaining said upper leg section of said telescoping lateral support leg in a stationary position relative to said lower leg section of said telescoping lateral support leg and a means for retaining said upper leg section of said telescoping perimeter leg in a stationary position relative to said lower leg section of said telescoping perimeter leg.

10. A perimeter safety system, comprising:
a plurality of perimeter safety stands, each perimeter safety stand comprising:
a main leg having an upper end, a middle section, and a lower end, said lower end capable of being detachably connected to a main leg panel foot, said upper end including an upper safety line receptacle, said middle section including a middle safety line receptacle;
a telescoping lateral support leg having an upper end and a lower end, said lower end capable of being detachably connected to a telescoping lateral support leg panel foot, said upper end capable of being detachably connected to said upper end of said main leg;
a telescoping perimeter leg having an upper end and a lower end, said lower end capable of being detachably connected to a telescoping perimeter leg panel foot, said upper end capable of being detachably connected to said upper end of said main leg;
wherein said main leg panel foot, said telescoping lateral support leg panel foot, and said telescoping perimeter leg panel foot are each capable of being detachably connected to a substructure of a pre-engineered roof system and to a standing seam of a concealed fastener roof.

11. The perimeter safety system according to claim 10, wherein said main leg panel foot, said telescoping lateral support leg panel foot, and said telescoping perimeter leg panel foot each comprises:
a top surface, a bottom surface and interconnecting side surfaces;
a first standing seam fixation means detachably connected to said bottom surface of said panel foot; and
a second standing seam fixation means detachably connected to said bottom surface of said panel foot.

12. The perimeter safety system according to claim 11, wherein said first standing seam fixation device and said second standing seam fixation device each comprises:
a U-shaped rectangular block having an internal cut-out capable of accommodating said standing seam of said concealed fastener roof panel;
a means for detachably connecting said standing seam fixation means to said bottom surface of said panel foot; and
a means for detachably securing said standing seam fixation means to said standing seam of said concealed fastener roof panel.

13. The perimeter safety system according to claim 11, wherein each of said telescoping lateral support leg and said telescoping perimeter leg comprises a lower leg section and an upper leg section, said upper leg section capable of being insertable into said lower leg section and extendable and retractable therein so that a length of said leg may be selectively adjusted.
